(19) United States
(12) Patent Application Publication
(10) Pub. No.: US 2023/0178987 A1
(43) Pub. Date: Jun. 8, 2023

(54) Device and Nethod for Controlling Energy Flows Between Components of an Energy System

(71) Applicant: Siemens Aktiengesellschaft, München (DE)

(72) Inventors: Stefan Niessen, Erlangen (DE); Sebastian Schreck, Nürnberg (DE); Jochen Schäfer, Nürnberg (DE); Sebastian Thiem, Neustadt an der Aisch (DE)

(73) Assignee: Siemens Aktiengesellschaft, München (DE)

(21) Appl. No.: 17/924,218

(22) PCT Filed: Mar. 22, 2021
(86) PCT No.: PCT/EP2021/057183

§ 371 Date: Nov. 9, 2022

(30) Foreign Application Priority Data
May 11, 2020 (DE) 10 2020 205 886.5

(51) Int. Cl. H02J 3/00

(52) U.S. Cl. CPC H02J 3/0075; H02J 3/008

(57) ABSTRACT

Various embodiments of the teachings herein include a device for controlling energy flows between participants in an energy network which are connected to one another via lines, the device comprising a processor configured to calculate the energy flows in advance for a period of time using an optimization process and to control the energy flows in the period of time on the basis of the result of the calculation. The processor is further configured to include losses that occur in the energy flows in the lines in the calculation using the optimization process.

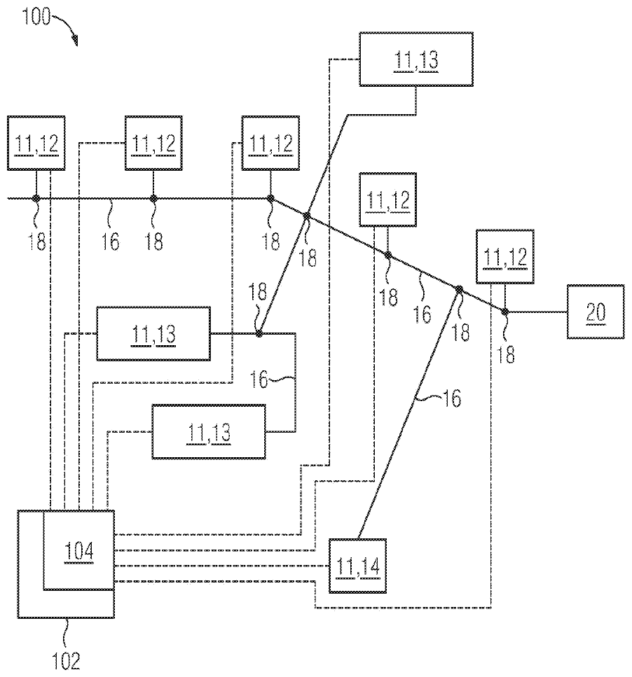

### CROSS-REFERENCE TO RELATED APPLICATIONS

This application is a U.S. National Stage Application of International Application No. PCT/EP2021/057183 filed Mar. 22, 2021, which designates the United States of America, and claims priority to DE Application No. 10 2020 205 886.5 filed May 11, 2020, the contents of which are hereby incorporated by reference in their entirety.

### TECHNICAL FIELD

The present disclosure relates to energy systems. Various embodiments of the teachings herein include devices and/or methods for controlling energy flows between participants in an energy network, where the participants can be energy consumers, energy producers or both (prosumers).

### BACKGROUND

Energy networks have at least two, but typically a large number of participants. Participants are energy producers, energy consumers or both. The participants can be private households, for example. These can act as pure energy consumers. In recent years, however, private households have also increasingly acted as energy producers or energy stores, for example if they have a photovoltaic system or a rechargeable battery (house battery). Participants can also be businesses such as shops, factories, farms or swimming pools. Like the private household, all of these act in most cases at least as energy consumers, but increasingly also as energy producers. Generators such as coal-fired power plants, gas turbines, large photovoltaic systems or wind energy systems also act as participants, typically as pure energy producers.

The energy network can be an electrical energy network, i.e. an electricity network. In this case, it can be the national supply network or a locally limited electrical network, in which case the locally limited electrical network can definitely be part of the national supply network, i.e. it does not have to be separate from it. In this case, the energy network can be assigned to a local energy market. The energy network can be a thermal network in which heat is exchanged between the participants.

To exchange energy, the participants are connected to one another by means of lines. There are typically no direct connections between all participants, but rather the connections are usually structured hierarchically. In power grids, for example, the energy network is typically divided into local grids that connect a locally limited group of participants. The local grids are connected to other local grids via medium-voltage lines. Finally, there are high-voltage lines for large-scale connection of the sub-grids.

The energy flows between the participants, i.e. the exchange of energy via the lines of the energy network, can be organized by a coordination platform. For this purpose, the coordination platform can carry out an optimization process. This means that the energy flows between the participants are calculated as efficiently or optimally as possible in advance, for example one day in advance (day-ahead). The energy flows are then controlled on the basis of the result of the optimization process.

The coordination platform can also be designed as a trading platform, so that the participants can submit sales offers and purchase offers. The sales offers and purchase offers with regard to a form of energy can be taken into account in the optimization, with typically the maximum possible and in this sense the best possible energy turnover being advantageous. A disadvantage of the known procedure for coordinating the energy flows is that, due to the physical structure of the lines, there is a discrepancy between the power fed in and the power that can be drawn, which is blamed unilaterally on the grid operators.

### SUMMARY

The teachings of the present disclosure may be used to avoid the stated disadvantages. In some embodiments of the teachings herein, there are devices and methods for controlling energy flows, which are used to avoid a unilateral burden on the grid operators due to losses occurring in the lines. In particular, the device and the method are intended to minimize the overall losses. As an example, some embodiments include a device (102) for controlling energy flows between participants (11) in an energy network (10) which are connected to one another via lines (16), wherein the device (102) is configured to calculate the energy flows in advance for a period of time using an optimization process and to control the energy flows in the period of time on the basis of the result of the calculation, characterized in that the device (102) is configured to include losses that occur in the energy flows in the lines (16) in the calculation using the optimization process.

In some embodiments, the device is configured to include a constraint, indicating the losses in the line (16), for at least some, in particular all, of the lines (16).

In some embodiments, there is a communication interface (104) for bidirectionally interchanging data with the participants (11), wherein the device (102) is configured to take into account at least some of the data received from participants (11) in the optimization process, in particular in constraints.

In some embodiments, the device (102) is configured to receive data containing information on the loss rates in the lines (16) of the energy network (10).

In some embodiments, the device is configured to send data, comprising control information for controlling the power flows, to the participants (11).

In some embodiments, the device (102) is configured to receive a minimum selling price from energy producers and a maximum buying price from energy consumers.

In some embodiments, the device (102) is configured to receive a maximum amount of energy that can be made available from energy producers and a maximum amount of energy that can be drawn from energy consumers.

In some embodiments, the device (102) is configured to use a definable portion of the transmitted power in the line (16) as a loss for at least one of the lines (16).

In some embodiments, the energy is electrical energy and in which Pᵥ=nRI² is used for one of the lines (16) as a loss in the line, where n is the number of electrical phases, Pᵥ is the power loss, R is the electrical resistance of the line and I is the current in the line (16).

In some embodiments, the energy is thermal energy and a function of the insulation of the line (16), the inlet temperature in the line (16), the outside temperature, the flow rate and/or the heat capacity in the line (16) is/are used for one of the lines (16) as a loss in the line (16).

In some embodiments, the device (102) is configured to include a sectionally linearized form for the losses in the optimization process.

As another example, some embodiments include a method for controlling energy flows between participants (11) in an energy network (10) which are connected to one another via lines (16), in which the energy flows are calculated in advance for a period of time using an optimization process, the energy flows in the period of time are controlled on the basis of the result of the calculation, characterized in that losses that occur in the energy flows in the lines (16) are included in the calculation using the optimization process.

As another example, some embodiments include a local energy market (100) having an energy network (10) and a plurality of participants (11) which are connected to one another via lines (16) and having a device (102) incorporating teachings of the present disclosure.

### BRIEF DESCRIPTION OF THE DRAWINGS

The teachings herein are described and explained in more detail below with reference to the single FIGURE of the drawing in connection with an exemplary embodiment.

The FIGURE schematically shows a local energy market 100 with a local electricity network 10.

### DETAILED DESCRIPTION

In some embodiments, a device incorporating teachings of the present disclosure is configured to control energy flows between participants in an energy network, wherein the participants are connected to one another via lines. Furthermore, the device is configured to calculate the energy flows in advance for a period of time using an optimization process and to control the energy flows in the period of time on the basis of the result of the calculation. In this case, the device is configured to include losses that occur in the energy flows in the lines in the calculation using the optimization process.

In some embodiments, the energy flows are calculated in advance for a period of time using an optimization process. Furthermore, the energy flows in the period of time are controlled on the basis of the result of the calculation. Losses that occur in the energy flows in the lines are included in this case in the calculation using the optimization process. As described at the outset, the participants may include a plurality of participants, each acting as a consumer, producer, store or a combination of these possibilities.

The grid itself is not taken into account in known energy markets. In other words, action is taken without grid boundary conditions and as if, for example, the power grid were a copper plate, which is not the case for either electrical or thermal grids. Due to this neglect of the grid properties, grid operators have to make up for their grid losses, since otherwise there would be a shortfall between production and consumption. The teachings of the present disclosure close this gap by taking into account the losses that occur in the lines between the participants and thus ensures that the grid operators are not unilaterally burdened with the losses.

In some embodiments, the embodiments of the teachings herein can be combined with the features of one of the dependent claims or also with those from a plurality of dependent claims. In some embodiments, the following features can also be additionally provided:

In some embodiments, the losses for one of the lines are described by a constraint for this line, with the constraint being included in the calculation. Some embodiments provide such a constraint for each of the lines in order to take into account all losses in the energy network.

In some embodiments, the device comprises a communication interface. This makes it possible to carry out the necessary interchange of data that is used to control the energy flows. The communication interface can be a connection to the Internet. In some embodiments, the communication interface can also have a connection to another, optionally also dedicated, communication grid.

A first expedient interchange of data of this type is the reception of data containing information on the loss rates in the lines of the energy network. These can be received from the grid operator, for example. It is possible in this case to receive these data again for each calculation period, for example a day; however, it is also possible to receive and buffer these data once or only in certain situations. Another expedient interchange of data of this type is the reception of a minimum selling price from energy producers and a maximum buying price from energy consumers. These values form the basis for the optimization process and thus the calculation of the energy flows.

Another expedient interchange of data of this type is the sending of data, comprising control information for controlling the power flows, to the participants. These data are the result of the optimization process or are determined from these results and returned to the participants in the energy network. In some embodiments, the communication interface is therefore designed to be bidirectional and allows data to be received and sent.

Another expedient interchange of data of this type is the reception of a maximum amount of energy that can be made available from energy producers and a maximum amount of energy that can be drawn from energy consumers.

In some embodiments, a definable portion of the transmitted power in the line is used as a loss for at least one of the lines. This makes the calculation as part of the optimization process as simple and time-saving as possible.

In some embodiments, the energy network can be an electrical energy network, i.e. an electricity network. The energy network can also be a thermal network in which one or more types of thermal energy, for example hot water, are exchanged between the participants. It is also possible for the energy network to be a network in which both electricity and thermal energy are exchanged. In such a network, there can be an overlap, i.e. common nodes for producers of both types of energy, for example in combined heat and power plants, but also for consumers of both forms of energy, such as private households.

If the energy in a line is electrical energy, Pᵥ=nRI² can be used as a loss in the line, where n is the number of electrical phases, Pᵥ is the power loss, R is the electrical resistance of the line and I is the current in the line.

If the energy is thermal energy, a function of the insulation of the line, the inlet temperature in the line, the outside temperature, the flow rate and/or the heat capacity in the line can be used as a loss in the line.

In some embodiments, a sectionally linearized form of the losses is included for the losses. Furthermore, a maximum amount of energy that can be provided by each energy producer and a maximum amount of energy that can be drawn by each energy consumer can be included in the optimization process.

The components and procedures described, in particular the control device and method and the participants, make it possible to provide a local energy market with an energy network that connects the participants. In the local energy market, the energies are exchanged locally, that is to say in a very limited area, taking into account the participants' specifications.

In some embodiments, a computer program, which can be loaded directly into a memory of an electronic computing device, can comprise program means to carry out the steps of one or more of the methods for controlling energy flows described herein when the computer program is executed in an electronic computing device. The computer program can be stored on an electronically readable data storage medium with electronically readable control information stored thereon, wherein the control information is configured in such a way that, when the data storage medium is used in an electronic computing device, it carries out the method for controlling energy flows.

The teachings of the present disclosure are described and explained in more detail below with reference to the single FIGURE of the drawing illustrating an exemplary embodiment. The FIGURE schematically shows a local energy market 100 with a local electricity network 10. The electricity network 10 comprises a number of participants 11, including a plurality of private households 12, businesses 13 and a wind power plant 14. The electricity network 10 is connected to the national supply network 20, that is to say does not form an island grid. The participants 11 are connected to one another by means of lines 16, wherein there is a direct connection between each participant 11 and every other participant 11, but rather a bus-like connection. The participants 11 can exchange electrical power with one another via the lines 16.

The wind power plant 14 is a pure electricity producer. Some of the private households 12 and businesses 13 act as pure electricity consumers, while others act as electricity consumers and electricity producers. The local energy market 100 is controlled and coordinated by a control device 102. To this end, the control device 102 controls or regulates the current flows between the participants 11 in the electricity network 10. For this purpose, the control device 102 is designed to calculate the current flows between the participants 11 using an optimization process for a period of time, for example from t=0 to t=T. To do this, the control device 102 requires physical and technical parameters of the participants 11, some of which are constant, but some of which also change from period of time to period of time.

In order to obtain these parameters, the control device 102 comprises a communication interface 104, for example a connection to the Internet. The participants 11 are also connected to the Internet, resulting in a bidirectional option for data interchange between the control device 102 and the participants 11. All energy producers in the energy network 10, i.e. in the given example the wind power plant 14 and those of the private households 12 and businesses 13, which have photovoltaic systems, for example, transmit at least their maximum amount of energy that can be provided at a time t E_{max,t}^{Producer}, for example in kilowatt hours, and their minimum selling price c_{min,t}^{Producer}, for example in cents per kilowatt hour, to the control device 102. The control device 102 is configured to receive these data from the participants 11. As an alternative or in addition to the selling price, a carbon dioxide emission and/or a primary energy use can be transmitted to the control device 102. The data packet used to store the maximum amount of energy that can be provided at a time t and the minimum selling price at the time t c_{min,t}^{Producer} can be referred to as a sales offer (sell order).

The energy consumers, i.e. the private households 12 and businesses 13, transmit at least their maximum amount of energy that can be drawn at a time t E_{max,t}^{Producer} for example in kilowatt hours, and their maximum buying price c_{max,t}^{Producer}, for example in cents per kilowatt hour, to the control device 102. In some embodiments, a carbon dioxide emission and/or a primary energy use can be transmitted to the control device 102. The data packet used to store the maximum amount of energy that can be drawn at a time t and the maximum buying price at the time t c_{min,t}^{Producer} can be referred to as a purchase offer (buy order).

If the energy network 10 also comprises energy stores, these transmit at least the maximum storage capacity that can be provided Eₘₐₓ^{ES}, for example in kilowatt hours, an initial state of charge Eₜ₌₀^{ES}, for example in kilowatt hours, the maximum charging power P_{Charging,max}^{ES}, the maximum discharging power P_{Discharging,max}^{ES}, for example in kilowatts, its charging efficiency η_{Charging}, its discharging efficiency η_{Discharging}, for example in percent, as well as a possible time-dependent minimum remuneration c_{Discharging,min,t}^{ES} for each amount of energy discharged, for example in cents per kilowatt hour. The data packet used to store the parameters mentioned for the energy store can be referred to as a storage offer (storage order).

The parameters transmitted using the data are used to parameterize the optimization process. An optimization process typically comprises a target function whose result is to be minimized or maximized. The target function comprises variables whose values are the result of the optimization process and parameters that do not change when the optimization is performed. The optimization process is parameterized when all parameters have a specific value. In the present case, the variables of the optimization process are the energy flows between the components. Typically, the energy flows are calculated one day in advance, i.e. for the coming day. The target function can be a total carbon dioxide emission of the energy system, a total primary energy use of the energy system and/or the total costs of the energy system.

In some embodiments, a target function according to the abovementioned parameters is given by:

$${\sum }_{t , n , k} [ ( {P}_{t , n , k}^{Producer} \cdot {c}_{min , t , k}^{Producer} - {P}_{t , n , k}^{Consumer} \cdot {c}_{max , t , n , k}^{Consumer} + {P}_{Discharge , t , n , k}^{ES} \cdot {c}_{Discharge . , t , n , k}^{ES} + {\sum }_{i} {P}_{i , n , t} \cdot {c}_{Fee , i , n , t}^{G} ) \cdot Δ {t}_{t} ] .$$

In this case, the index k stands for the participant 11, the index n for the network node 18 of the electricity network 10 and the index t for the time t. The inner summation index i stands for a further network node 18 which is connected to the network node 18 n.

P_{t,n,k}^{Producer}, P_{t,n,k}^{Consumer}, P_{Discharge,t,n,k}^{ES} and P_{i,n,t} are the variables of the target function. The optimization process, which is carried out by means of the control device 102, minimizes the target function mentioned and determines or calculates the variables P_{t,n,k}^{Producer}, P_{t,n,k}^{Consumer}, P_{Discharge,t,n,k}^{ES} and P_{i,n,t}. In this case, P_{t,n,k}^{Producer} is the power of the energy producer k at the network node n at the time t, P_{t,n,k}^{Consumer} is the power of the energy consumer k at the network node n at the time t, P_{Discharge,t,n,k}^{ES} is the discharging power of the energy store k at the network node n at the time t, and P_{i,n,t} is the effective line capacity between a network node i and the network node n at the time t, with a grid fee c_{Fee,i,n,t}^{G} arising for using the energy transmission grid for this purpose.

The optimization problem, i.e. calculating the maximum or minimum of the target function, typically occurs under constraints. For example, physically

$${\sum }_{k} {P}_{t , n , k}^{Producer} - {\sum }_{k} {P}_{t , n , k}^{Consumer} + {\sum }_{i} {P}_{i , n , t , out} - {\sum }_{i} {P}_{n , i , t , in} - {\sum }_{k} {P}_{Charging , t , n , k}^{ES} + {\sum }_{k} {P}_{Discharging , t , n , k}^{ES} = 0$$

must be fulfilled for all network nodes 18 n and all times t within the period of time to be considered.

In this case, P_{i,n,t,out} stands for a power that will be drawn from a line 16 at the network node 18 n and P_{i,n,t,in} stands for the power that is fed into the line at the network node 18 n.

Furthermore, constraints Pₜ^{Producer}Δtᵣ≤E_{max;t}^{Producer} are provided for each energy producer, that is to say for example the wind energy system 14, and Pₜ^{Consumer}Δtₜ≤E_{max;t}^{Consumer} for each energy consumer, as well P_{Charging,t}^{ES}≤P_{Charging,max,t}^{ES}, P_{Discharging,t}^{ES}≤P_{Discharging,max,t}^{ES} and Eₜ^{ES}−Eₜ₋₁^{ES}=[P_{Charging,t}^{ES}η_{Charging}−P_{Discharging,t}^{ES}/η_{Discharging}]·Δtₜ for energy stores (flex type 1).

A displaceable load can be modeled using the constraint Σₜ_{_{Start}}^{t}^{_{End}} Pₜ^{Consumer}·Δtₜ≤Eₘₐₓ^{Consumer} and can thus be taken into account in the optimization process.

Other physical/technical constraints, for example the fact that powers only assume positive values, or grid boundary conditions, can be taken into account. In particular, the type of electricity, for example electricity from photovoltaic production, and/or preferences of the energy consumers and/or preferences of the energy producers can be taken into account in the optimization process by means of further constraints. For a plurality of types of electricity (types of electricity), the above equations each apply individually. In the case of equations with a physical basis, for example physical boundary conditions for energy stores, the sums of the powers from the individual types of electricity are formed.

The following therefore still apply to a power flow from node i to j: P_{i,j}, P_{j,i}>=0 and P_{i,j}<=P_{i,j,t,max}.

In order to take line losses into account, the following additional constraint is introduced, in which the powers drawn and fed in that were introduced above are linked:

P_{i,j,out}=P_{i,j,in}*(1−α_{i,j})

The loss rate α_{i,j} can be a constant, for example. In other configurations, it is also possible to use a detailed formulation in which the loss rate is dependent on the current intensity and line impedance. The active power losses in the three-phase electrical grid (grid power loss) are proportional to the real part of the grid impedance and the square of the current intensity (symmetrical load case):

Pᵥ=3RI²

Assuming that the same nominal voltage prevails in a part of the local energy market 100, for example below a transformer station, the grid losses are therefore quadratically dependent on the transmitted active power. The nominal voltage can be 400 V, for example. Since the transmitted active powers are included as a variable in the matching algorithm, the losses cannot only be calculated as a constant portion, but can also be included in a more precise form if the corresponding line impedances are known. Some embodiments use a stepwise linearization of the loss coefficient in the optimization problem in order to avoid the complexity of a quadratic optimization.

After the energy flows have been calculated using the control device 102, these calculated values are transferred to the participants 11, that is to say they are transmitted using the control device 102 or via the communication interface 104 of the control device 102. This ensures that the participants 11, and thus the energy system, are operated in the best possible way according to the solution of the optimization process. In other words, the control device 102 controls the participants 11 based on the solution of the optimization process. The efficiency of the electricity network 10, for example a maximum energy turnover, is thus improved.

The optimization problem described can be set up, parameterized and then solved using the following process (time sequence):

The sequence of the process used to organize the operation of the electricity network 10 is as follows:

In a first step, the operator of the supply network for the electricity network 10 determines the loss coefficients α_{i,j} of the respective lines 16 on the day before energy trading. In this case, these loss coefficients can be constant values or can be specified, for example, as a stepwise function on the basis of the power α_{i,j}(Pₜ).

In a second step, the operator of the supply network 20 transmits the grid topology and the calculated loss coefficients to the local energy market 100, i.e. the platform of the operator of the local energy market 100. The loss coefficients are thus available to the control device 102.

The participants 11 in the local energy market 100 transmit their respective offers for the drawing and feed-in of electricity to the control device 102. As a result, the control device 102 has the data needed to solve the described optimization problem in a third step, taking into account all the constraints. If the period of time calculated in this way by the optimization process is reached, for example the next day, the electricity network 10 is operated in a fourth step based on the solution to the optimization problem.

In some embodiments, the losses occurring in the lines 16 are taken into account from the outset. As a result, the operator of the supply network 20 is not forced to feed in additional power that is not consumed by any consumer and is therefore not paid for either.

The method described can also be used for district heating grids. In this case, the loss rate is α_{i,j} and can, for example, be a function of the power, as well as depend on the inlet temperature in the district heating grid, the ground/outside temperature or other environmental conditions. The dependency of the loss rate on power, inlet temperature and ground temperature can be described by a model whose parameters can be determined by means of the data recorded in the control device 102.

### LIST OF REFERENCE SIGNS

10 Electricity network
11 Participant
12 Private household
13 Business
14 Wind power plant
16 Line
18 Network node
20 Supply network
100 Local energy market
102 Control device
104 Communication interface

What is claimed is:

1. A device for controlling energy flows between participants in an energy network which are connected to one another via lines, the device comprising:
a processor configured to calculate the energy flows in advance for a period of time using an optimization process and to control the energy flows in the period of time on the basis of the result of the calculation;
wherein the processor is further configured to include losses that occur in the energy flows in the lines in the calculation using the optimization process.

2. The device as claimed in claim 1, wherein the processor is further configured to include a constraint indicating the losses in the line for at least some of the lines.

3. The device as claimed in claim 1, further comprising a communication interface for bidirectionally interchanging data with the participants;
wherein the processor is configured to take into account at least some of the data received from participants in the optimization process.

4. The device as claimed in claim 3, wherein the processor further accounts for loss rates in the lines of the energy network.

5. The device as claimed in claim 3, wherein the processor is further configured to send data comprising control information for controlling the power flows to the participants.

6. The device as claimed in claim 3, wherein the processor is further configured to receive a minimum selling price from energy producers and a maximum buying price from energy consumers.

7. The device as claimed in claim 3, the processor further configured to receive a maximum amount of energy made available from energy producers and a maximum amount of energy drawn from energy consumers.

8. The device as claimed in claim 1, wherein the processor is further configured to use a definable portion of the transmitted power in the line as a loss for at least one of the lines.

9. The device as claimed in claim 1, wherein:
the energy is electrical energy; and
Pᵥ=nRI² is used for one of the lines as a loss in the line, where n is the number of electrical phases, Pᵥ is the power loss, R is the electrical resistance of the line, and I is the current in the line.

10. The device as claimed in claim 1, wherein:
the energy is thermal energy; and
a function of the insulation of the line, the inlet temperature in the line, the outside temperature, the flow rate and/or the heat capacity in the line is/are used for one of the lines as a loss in the line.

11. The device as claimed in claim 1, wherein the processor is further configured to include a sectionally linearized form for the losses in the optimization process.

12. A method for controlling energy flows between participants in an energy network which are connected to one another via lines, the method comprising:
calculating energy flows in advance for a period of time using an optimization process; and
controlling the energy flows in the period of time on the basis of the result of the calculation;
wherein losses occurring in the energy flows in the lines are included in the calculation using the optimization process.

13. (canceled)
